(19) United States
(12) Patent Application Publication
(10) Pub. No.: US 2025/0381751 A1
(43) Pub. Date: Dec. 18, 2025

(54) Three-dimensional molded part made of fiber-containing material and molding tool for the production of molded parts made of fiber-containing material

(71) Applicant: Kiefel GmbH, Freilassing (DE)

(72) Inventors: Till Rupp, Waging am See (DE); Richard Hagenauer, Saaldorf-Surheim (DE)

(21) Appl. No.: 19/241,357

(22) Filed: Jun. 17, 2025

(30) Foreign Application Priority Data
Jun. 18, 2024 (DE) 10 2024 117 159.6

(51) Int. Cl. B31B 50/88; B31B 50/59

(52) U.S. Cl. CPC B31B 50/88; B31B 50/592

(57) ABSTRACT

A three-dimensional molded part made of fiber-containing material and a molding tool for producing molded parts made of fiber-containing material are described. The three-dimensional molded part is produced in a manufacturing process under pressure and thermal influence. A surface of the molded part has at least one design element and/or functional element that is formed by at least one region with reduced material thickness. The material thickness of the at least one region decreases with an increasing molded part height in a molding direction.

### PRIORITY CLAIM

The present application claims priority under 35 U.S.C. § 119 to German Patent Application No. DE 10 2024 117 159.6, filed Jun. 18, 2024, the disclosure of which is incorporated by reference herein in its entirety.

### TECHNICAL FIELD

A three-dimensional molded part made of fiber-containing material and a molding tool for producing molded parts made of fiber-containing material are described.

### BACKGROUND

Fiber-containing materials are increasingly used, for example, to produce packaging for food (e.g., trays, capsules, boxes, etc.) and consumer goods (e.g., electronic devices, etc.) as well as beverage containers. The fiber-containing materials can have natural fibers, which are obtained, for example, from renewable raw materials or waste paper. The natural fibers can be mixed in a so-called pulp with water and, optionally, further additives, such as starch, and then formed. Additives can also have an effect on color, barrier properties and mechanical properties. A pulp can have a proportion of natural fibers of, for example, 0.1 to 10 wt. %. The proportion of natural fibers can vary according to the method used for the production of packaging, etc., and the product properties of the product to be produced. Fibers, such as natural fibers, can also be introduced into molding tools in a dry state and processed or formed therein. Alternatively, such fibers can be processed into starting materials for subsequent shaping. Starting materials for further processing can, for example, be so-called webs or sheets, such as airlaid, fluff pulp, paper, etc., as well as multi-layer arrangements made of the above materials, made of a fiber-containing material, which are then formed in a molding tool.

During the production of products or molded parts from a fiber-containing material, the evaporating water is extracted as standard during a pressing process at high temperatures and high pressure in a so-called wet process. Even in dry molding processes, the so-called dry process, steam can be extracted during a pressing process with high temperatures and high pressure if the fiber-containing material has a water content of about 20 wt. % or more or has at least been locally moistened. To extract the steam, the molding surfaces of molding tools have small openings that are connected to corresponding channels and devices. During the pressing process, small elevations form on the surfaces of the molded parts, with the fiber-containing material being pressed into the openings. Extraction can support the formation of elevations.

Such elevations arise as a result of extraction, where with increasing moisture content of the material to be pressed in cavities of molding tools, more and more steam is generated, which must be discharged via openings on at least one molding surface of a molding tool. The elevations are perceptible both visually and haptically on a finished molded part.

However, the elevations are perceived as disruptive with regard to design specifications and aesthetic aspects, so that the demand for alternative molded bodies made of renewable and easily recyclable fiber-containing materials, which can also be compostable, is very low. This is a crucial disadvantage, especially with regard to the goal of using more sustainable products. In addition, such elevations have the disadvantage that when used, for example as a capsule for a coffee machine or as a lid for a drinking cup, they do not sit flush with contact surfaces (e.g., brewing chamber for a coffee capsule) or do not fit optimally against the edge of a cup, so that a sufficient sealing effect cannot be achieved. Furthermore, such elevations on a lid can make drinking difficult.

### SUMMARY

### Object

By contrast, it is an object to provide a solution that eliminates the disadvantages of the prior art and enables the formation of molded parts from fiber-containing material and provides molded parts from fiber-containing material that are simply designed, are not subject to any functional restrictions in the use of molded parts due to elevations resulting from the manufacturing process and take aesthetic requirements into account.

### Solution

The above-mentioned object is achieved by a three-dimensional molded part made of fiber-containing material, which part is produced in a manufacturing process under pressure and thermal influence, where a surface of the molded part has at least one design element and/or functional element that is formed by at least one region with reduced material thickness, where the material thickness of the at least one region decreases with an increasing molded part height in a molding direction.

The formation of design elements and/or functional elements on the surface of molded parts made of fiber-containing material with a decreasing material thickness offers the advantage that, for example, elevations or other decorative or information elements can be introduced into this region, in particular embossed, which do not or only insignificantly protrude beyond the surface of the molded part, since these elements can extend from a region that is set back from the surface. This makes it possible to provide molded parts that do not have any protruding elements on the surface in the region of the design element and/or the functional element compared to adjacent regions of the surface. In addition, design elements and/or functional elements can be integrated into a surface without visually disturbing the surface.

The design elements and/or functional elements do not have the same material thickness across their entire length, but the difference in material thickness is hardly noticeable. Recessed regions in molded parts made of fiber-containing material are usually visually and haptically perceptible if they show a certain reduction in material thickness. In the solution presented, the reduction of the material thickness does not begin suddenly but begins continuously and can, for example, end abruptly at a lower end in the molding direction. In order to create essentially sharply separated regions despite the continuous material removal, for example, a weaker reduction in the material thickness can initially be provided in a region of the design element and/or functional element, followed by a region with reduced material thickness that has a stronger reduction in the material thickness. For the optimal representation of design elements and/or functional elements, a reduction in material thickness can begin in front of a design element and/or functional element in order to then have the required reduced material thickness in the region of the design element and/or functional element, which is visually and/or haptically perceptible. This means that the “initial region” of the reduction in the molding direction does not fall into the region of the design element and/or functional element and is not haptically and/or visually perceptible.

In further embodiments, the surface can have an orientation inclined relative to a vertical axis of the molded part, so that a cross-sectional area of the molded part increases in the molding direction.

In further embodiments, the design element and/or the functional element can have at least one elevation that is formed by fiber-containing material that, during the production of the molded part, has been sucked and/or pressed into a corresponding opening in a molding surface of a molding tool when steam that escapes from the fiber-containing material during pressing is removed.

In further embodiments, the at least one elevation can be arranged in a first surface portion that has a different configuration than an adjacent at least one second surface section, where the at least one elevation is integrated into the configuration of the first surface section. This also includes regions with reduced material thickness. In particular, this may include depressions, transitions between edge, side and/or base regions, embossing, etc.

In further embodiments, the surface, the design element and/or the functional element can have elevations formed by fiber-containing material that, during the production of the molded part, have been sucked and/or pressed into corresponding openings in a molding surface of a molding tool when steam that escapes from the fiber-containing material during pressing is removed, and where the elevations form at least one pattern. In further embodiments, the at least one pattern may represent a product feature, a product representation, an instruction on the use of a product and/or on the disposal of the molded part. For example, symbols, letters, numbers, etc. can be formed by depressions, protruding regions and other surface characteristics (e.g., structure, roughness, etc.), where the at least one pattern is integrated in such a surface portion. Furthermore, a pattern can, for example, form a functional element that serves, for example, to snap a first molded part to a corresponding part. A functional element can, for example, form an undercut, which is provided for cups and lids, for example, to ensure a secure hold.

The arrangement of elevations as a pattern offers, on the one hand, a visually appealing appearance, which can also be used to display product information, usage and disposal instructions, and, on the other hand, can take into account a technical aspect, whereby patterns can, for example, be designed in the form of a line that facilitates insertion into a receiving space (e.g., brewing space for a coffee capsule) or prevents incorrect insertion (formation of elevations to provide elements according to the “Poka Yoke” principle).

In further embodiments, the at least one pattern can be integrated at least partially into a transition between at least a first surface section and a second surface section of the surface and/or into a design element on the surface.

When integrating the at least one pattern into a first surface portion with a configuration that differs from a second surface portion, the at least one pattern can be integrated into a portion or region (first surface portion) of a surface of the molded part that already differs in its configuration (shape, depth, thickness, etc.) and thus also visually and haptically from the remaining surface region or neighboring regions (second surface portion). This ensures that the elevations of the at least one pattern do not have a disturbing visual appearance because they are integrated into a region that is already formed differently for design and/or technical reasons, and are not disturbing when using the molded part because the elevations do not protrude from a contact surface or plane due to its integration into a differently formed region, for example, so that no “locking points,” “spacer knobs” or the like are formed.

For example, elevations of the at least one pattern can be provided in regions of a molded part with reduced material thickness, so that no elevations protrude from the surface to the extent that the elevations in the regions with reduced material thickness protrude at most to such an extent that their protruding ends are substantially flush with the surface profile of the surrounding regions of the second surface portion. In other words, elevations cannot protrude above a surface plane that extends over the first surface portion and the second surface portion. Furthermore, elevations can also protrude deliberately from a surface plane, where the elevations are part of a configuration.

The different configuration of a first surface portion can be formed in different ways. For example, the configuration can include transitions, general elevations, i.e., thickened regions, design elements, depressions, formation elements, undercuts etc. Elevations can be provided in a first surface portion on an outer surface and/or inner surface. The elevations themselves usually extend perpendicularly from the surface and have small dimensions. For example, elevations can have diameters of 0.5 to 2 mm or corresponding cross sections. The height of elevations can, for example, be in the range of 0.2 to 1.5 mm. The dimensions may also be designed according to the layer thickness of the molded part in the region of the material layer assigned to the surface and the dimensions of the molded part as well as the material used and the intended use and may deviate from the above exemplary dimensions. Molded parts can be designed in different ways and, for example, have a round or polygonal cross section.

In further embodiments, the at least one design element, the functional element and/or pattern can extend over a wall region, an edge region and/or a bottom region of a molded part.

In further embodiments, the elevations can be arranged on an outer surface of the molded part and extend away from the outer surface of the molded part.

In further embodiments, at least one elevation can have an at least in portions oval, elongate, polygonal or round cross section. The at least one elevation can be part of a design element or can constitute a substantial component thereof. In further embodiments, patterns can contain information and/or represent a functional element that serves, for example, as a spacing element, guide element and/or marking. Thereby, in further embodiments, at least one spacing element can be designed as holding or spacer ribs (e.g., for containers for hot or cold food/drinks) or as rough gripping surface with a plurality of elevations.

In further embodiments, at least one elevation itself can be designed as a design element and/or functional element, where the at least one elevation has regions with different material thicknesses.

In further embodiments, the fiber-containing material may include at least 50 wt. % of plant fibers and/or cellulose fibers.

The above-mentioned object is also achieved by a molding tool for producing molded parts from fiber-containing material according to one of the above embodiments, where the molding tool has at least one molding surface for pressing fiber-containing material into a three-dimensional molded body, where the at least one molding surface surrounds a molding space for pressing the fiber-containing material, and where the at least one molding surface has at least one molded element that projects increasingly from the at least one molding surface in the molding direction.

The at least one molded element can substantially only protrude into the molding space to such an extent that it runs parallel to the molding direction, where the associated molding surface section of the molding surface, in particular in the region for a side wall of a molded part to be produced, is inclined relative to the molding direction, i.e., the cross section or diameter of the molding space increases in the molding direction.

This results in a simple creation of design elements that have a recess for the formation of design elements and/or functional elements, with no undercuts or movable tool components being required in the molding tool for the formation of the design elements and/or functional elements and regions with a lower material thickness.

The molded parts specified above with regard to the molded part also apply accordingly to a molding tool for producing such molded parts, where molded parts can be produced using simple means without a complex and vulnerable tool design, which fulfills the above requirements and solves the problem mentioned at the outset.

Further features, embodiments and advantages result from the following illustration of exemplary embodiments with reference to the figures.

### BRIEF DESCRIPTION OF THE FIGURES

In the figures:

FIG. 1 depicts a schematic representation of a molded part made of fiber-containing material in a perspective view;

FIG. 2 depicts a schematic representation of a further molded part made of fiber-containing material in a perspective view;

FIGS. 3A-3B depict schematic representations of the formation of a design element on the surface of a molded part made of fiber-containing material;

FIG. 4 depicts a schematic representation of a sectional view of a molded part made of fiber-containing material with differently formed elevations and design elements;

FIG. 5 depicts schematic representations of the formation of elevations and design elements;

FIG. 6 depicts a schematic representation of a molding tool for producing molded parts from fiber-containing material;

FIG. 7 depicts a schematic representation of the formation of a design element on the surface of a molded part made of fiber-containing material in a further embodiment; and

FIGS. 8A-8B depict schematic representations of a molded part with functional elements.

### DETAILED DESCRIPTION

Various embodiments of the technical teaching described herein are shown below with reference to the figures. Identical reference signs are used in the figure description for identical components, parts and processes. Components, parts and processes that are not substantial to the technical teachings disclosed herein or that are obvious to a person skilled in the art are not explicitly reproduced. Features specified in the singular also include the plural unless explicitly stated otherwise. This applies in particular to statements such as “a” or “one.”

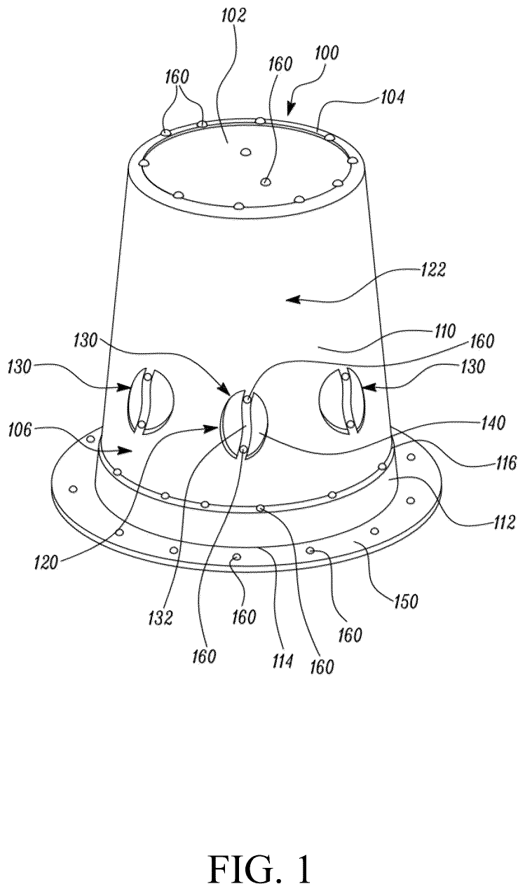

FIG. 1 depicts a schematic representation of a molded part 100 made of fiber-containing material in a perspective view. The molded part 100 depicted in FIG. 1 is designed as a capsule. In the embodiment shown, the capsule is designed as a coffee capsule and is used to hold coffee powder. Before filling and after the production of the molded part 100 depicted in FIG. 1, a coating (lamination, coating, etc.) of an inner receiving space or an inner surface can be carried out to provide a barrier. Alternatively or additionally, after filling and sealing, the capsule may be subjected to a covering (lamination, coating, etc.) on its outer surface in order to achieve a barrier effect. Another alternative or additional possibility for providing barrier properties for a molded part 100 may be the introduction of additives into the fiber-containing material.

The molded part 100 has a base 102 that has a base ring 104. The base ring 104 protrudes from the surface of the base 102. The molded part 100 has an adjoining circumferential side wall 110. The side wall 110 is slightly inclined relative to the base 102, where the diameter of a receiving space of the molded part 100 increases from the base 102 to an edge 150. In the exemplary embodiment shown, the molded part 100 is substantially rotationally symmetrical. The side wall 110 has a thickened or stepped ring 112. In the region of the ring 112, the material thickness or the thickness of the side wall 110 can be stronger or greater than in the remaining region. Alternatively, the cross section or diameter of the side wall 110 may increase in the region of the ring 112 in order to provide a substantially constant wall thickness over the entire side wall 110. A second transition 116 having a radius is formed between the ring 112 and the side wall 110. A first transition 114 from the ring 112 to an edge 150 also has a radius. In the embodiment shown, elevations 160 are formed at various locations on the surface 106 of the molded part 100.

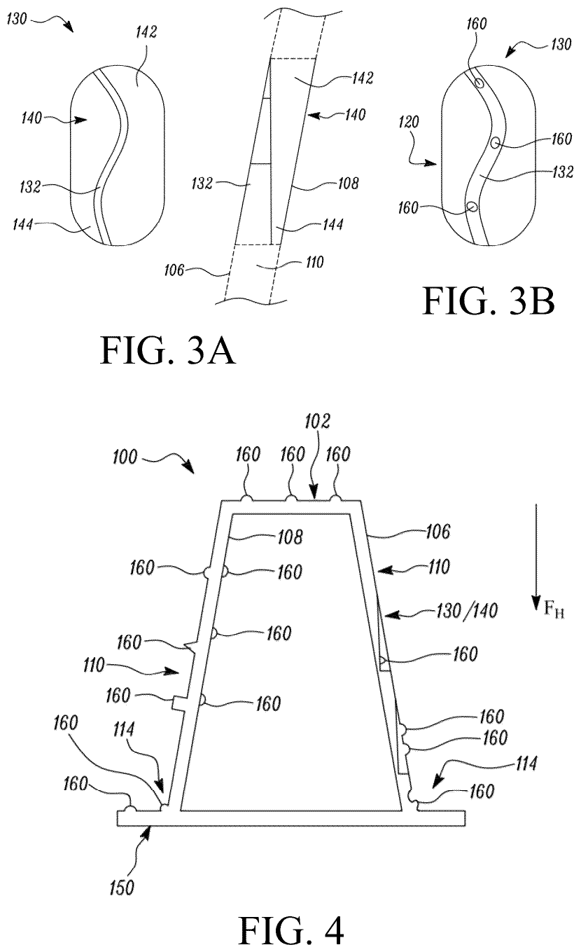

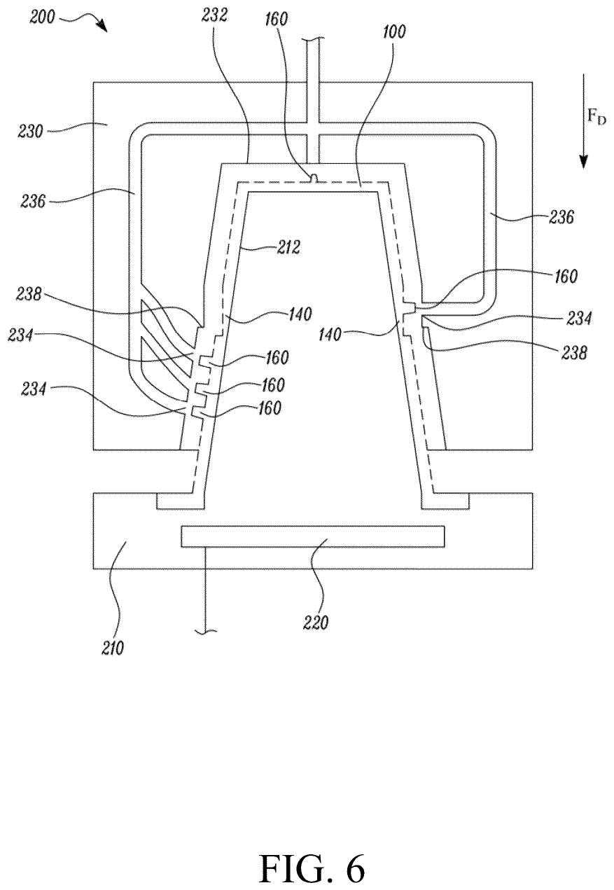

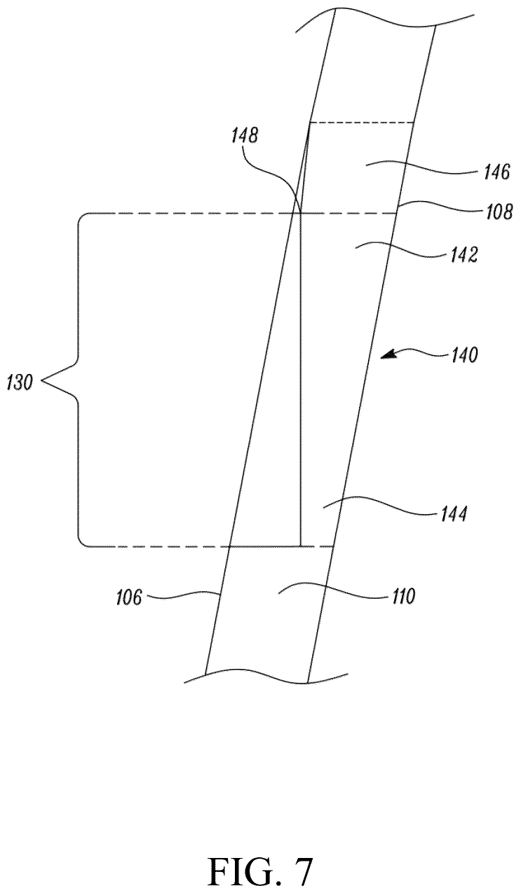

Three design elements 130 are integrated into the side wall 110 and are formed during the pressing of the fiber-containing material in a molding tool 200 (see, for example, FIG. 6). The design elements 130 are designed as coffee beans in FIG. 1, since the embodiment represents a capsule for coffee. It is evident that other design elements 130 can also be created by appropriate shaping and design of the surface 106. The design elements 130 have a region 140 with reduced wall thickness, as described in more detail with reference to FIG. 3A and FIG. 7. The side wall 110 forms a second surface portion 122 on its surface, which here has a curved profile. The portions with the design elements 130 form first surface portions 120.

In the embodiment according to FIG. 1, elevations 160, which are formed during a molding process during the hot pressing of fiber-containing material due to the removal of steam that escapes from the fiber-containing material during pressing under high pressure (0.2 to 300 N/mm²) and high temperatures (120-300° C.), via corresponding steam holes (openings 234; see, e.g., FIG. 6) in molding surfaces 232 of a molding tool 200, are integrated into the embodiment of the first surface portions 120 or design elements 130.

By integrating the elevations 160 into the embodiment of the design elements 130 (“coffee bean”), these elevations 160 are barely perceptible and blend in with the embodiment both visually and haptically. In the exemplary embodiment with the coffee bean, the design element 130 has a web 132 in the first surface portion 120. The web 132 protrudes from the neighboring regions 140, each of which has a smaller material thickness or wall thickness than the web 132 and the second surface portion 122. The elevations 160 on the webs 132 are thus integrated into the different embodiment of the design element 130 compared to the second surface portion 122.

Furthermore, elevations 160 are integrated into the transitions 114, 116 and a transition region between the base ring 104 and the base 102 or into the base ring 104, so that these elevations do not have a significant influence on the use of the molded part 100, i.e., they do not form any protruding elements that are arranged on visible surfaces on the surface 106 or that are disruptive to abutment against corresponding surfaces of a utilization machine (e.g., coffee machine). The elevations 160 on the base 102 and on the edge 150 may also be omitted in further embodiments. In the exemplary embodiment, these are shown as an embodiment option on further first surface portions that differ from the remaining surface 106, in particular the surface 106 of the side wall 110 in the second surface portion 122, due to the orientation and arrangement as well as the surface characteristics. The base 102 has, for example, a surface offset from the base ring 104, so that the central elevations 160 do not interfere with the use of the molded part 100 and are also barely perceptible. The edge 150 has a rougher surface, so that the elevations 160 on the edge 150 are barely perceptible both visually and haptically and are also not located on relevant functional surfaces, in particular for later use (e.g., coffee machine).

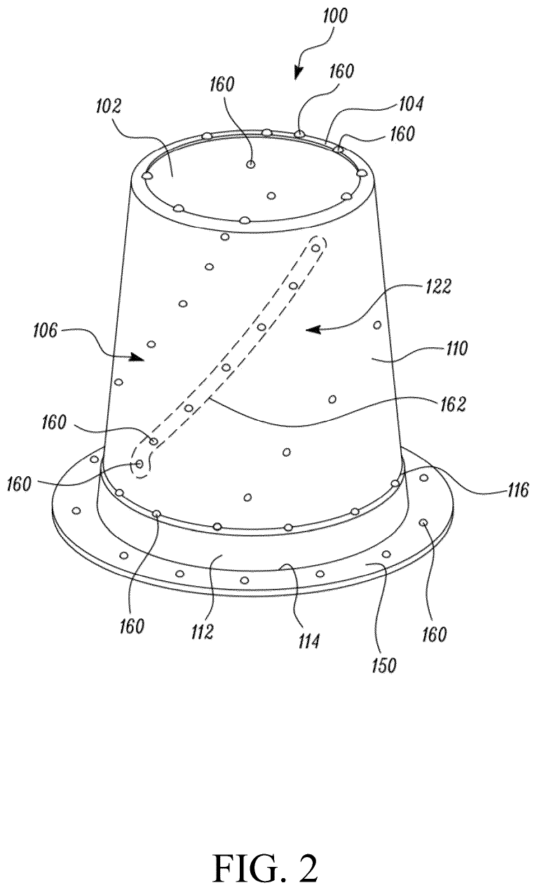

FIG. 2 depicts a schematic representation of another molded part 100 made of fiber-containing material in a perspective view. In the embodiment depicted, a plurality of elevations 160 on the surface of the side wall 110 form a pattern 162, as depicted schematically by the dashed line. A pattern 162 may also extend beyond the side wall 110 to the edge 150 and/or the base 102. In further embodiments, the base 102 and/or the edge 150 may also have a pattern 162 of several elevations 160. Instead of a curved profile, as shown in FIG. 2, a pattern 162 can also form a letter, a number, a character or a corresponding letter, number and/or character string. In further embodiments, a pattern 162 can also form functional elements, which can be designed as holding or spacer ribs (e.g., for containers for hot or cold food/drinks) or as rough gripping surface with a plurality of elevations 160.

FIGS. 3A-3B depict schematic representations of the formation of a design element 130 on the surface of a molded part 100 made of fiber-containing material, the formation on an outer surface 106 being described here. In further embodiments, an analogous embodiment can also be provided on an inner surface 108 with a corresponding inclination of a side wall 110.

FIG. 3A depicts both a design element 130 formed as a coffee bean and a section through the design element 130. The design element 130 is formed by at least one region 140 with reduced material thickness, where the material thickness of the at least one region 140 decreases with an increasing molded part height F_{H} in a molding direction F_{D}.

The design element 130 has a region 140 with reduced material thickness or wall thickness, as can be seen in particular in the sectional view. In a first sub-region 142, the side wall 110 has a decreasing material thickness in the region of the design element 130, which decreases further up to a second sub-region 144 and reaches its maximum. The material or wall thickness along the web 132 remains unchanged in the exemplary embodiment. In further embodiments, the material or wall thickness of the web 132 can also decrease, where the degree of decrease can be different from the regions 140 in order to achieve a visually and haptically perceptible difference between regions 140 and a web 132. This may be necessary in particular if, for example, a web 132 has a profile that, during demolding, collides with the molding surface of a molding tool 200 and could be damaged in the process.

In further embodiments, the formation of a step in the first region 142 relative to the outer surface 106 can be tolerated in order, for example, to achieve a delimitation between the first region 142 and the surface 106. Such a step can form an undercut in a molded part 100. Up to a certain depth (e.g., 1 mm) or undercut formation, demolding can thus take place after the molding process in a molding tool without moving parts, without damaging the molded part 100.

As depicted in FIG. 3A, the material thickness increases with increasing molded part height F_{H} (see FIG. 4), so that demolding can take place without the need for additional movable molded parts to be moved on a molding surface of a molding tool part and, for example, orthogonal to a molding direction F_{D}. The formation of design elements 130 is created here by increasingly thinner regions.

FIG. 3B depicts a further variant for a design element 130 formed as a coffee bean, where elevations are formed along the web 132. For this purpose, the design element 130 can have regions 140 with a lower material thickness, analogous to the embodiment according to FIG. 3A, where the material thickness can also decrease with increasing molded part height F_{H} as in FIG. 3A.

In addition, the material or wall thickness of the web 132 can also decrease or an elevation 160 can be provided in a sub-region 142 or 144 so that the elevation 160 does not protrude or only protrudes slightly from the overall surface or the surface of a second surface portion 122, as depicted schematically in FIG. 4, for example.

FIG. 7 depicts a schematic representation of the formation of a design element 130 on the surface 106 of a molded part 100 made of fiber-containing material in a further embodiment, where an initial region 146 is provided in front of the partial regions 142, 144 with reduced material thickness, which initial region also has a reduced material thickness. In the exemplary embodiment shown, the initial region 146 is not part of the design element 130 and serves to provide a minimum reduction in the material thickness in the region of the design element 130 so that the design element 130 is clearly demarcated from the surrounding surface 106 of the molded part 100 and is thus visually and/or haptically demarcated. Since there is no homogeneous decrease in material thickness between the initial region 146 and the first partial region 142 as in the remaining region 140, a ridge 148 is formed that provides a clear demarcation between the design element 130 and the remaining surface 106. The initial region 146 is barely perceptible and is perceived as a component of the surface formation in the second surface section 122 and not as a component of the first surface section 120 or the design element 130.

FIG. 4 depicts a schematic representation of a sectional view of a molded part 100 made of fiber-containing material with differently formed elevations 160 and design elements 130.

The molded part 100 is shown, like the molded parts 100 from FIGS. 1 and 2, in an orientation advantageous for production, where the molded part height F_{H} is determined from the base 102. The individual elevations 160 are depicted on both an outer surface 106 and an inner surface 108 in order to schematically depict the possible positions for elevations 160. Furthermore, FIG. 4 depicts the integration of elevations 160 in transitions 114, where the transitions 114 have a radius that is, for example, in the range of 0.2 to 5 mm. As depicted in FIG. 4 on the right side of the molded part 100, a circumferential groove or a local depression is formed in the transition 114, in which an elevation 160 is integrated, so that the elevation 160 (e.g., raised portion) hardly protrudes from the outside and is therefore neither visually nor haptically perceptible and/or is not detrimental to a function or use. Thus, in further embodiments, elevations 160 can be accommodated in depressions (grooves, craters, etc.), where the elevations 160 thus do not protrude, or only slightly protrude, beyond the surface of the surrounding second surface portions 122.

On the right side, the side wall 110 of the molded part 100 has two regions 140 with reduced wall thickness, where one region has a web 132 or an element designed analogously thereto, on which the elevations 160 are formed and protrude from the design element 130 (lower example), or the elevations 160 are arranged in, for example, a sub-region 144 with a small material thickness, so that the elevation 160 does not protrude above the surface of the surrounding second surface portion 122 (upper example).

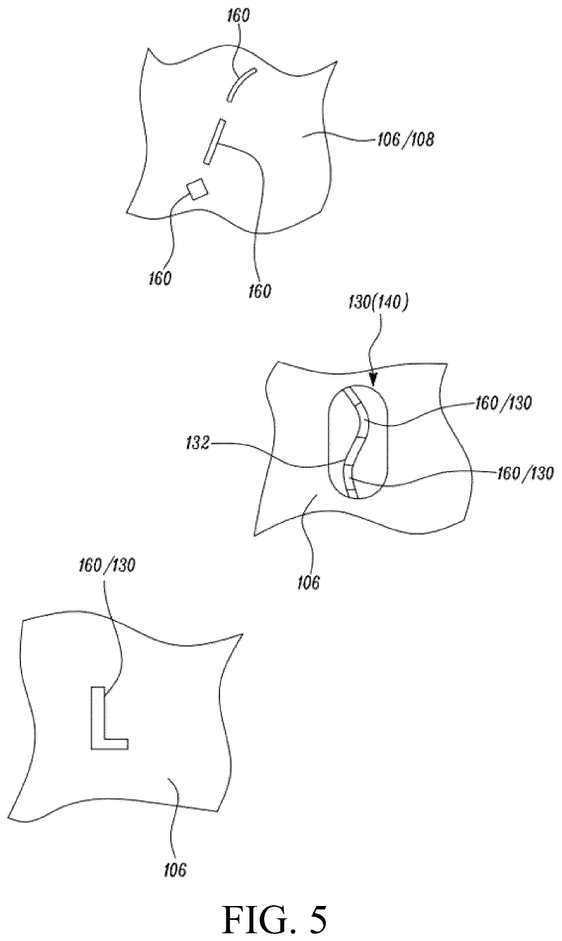

FIG. 5 depicts schematic representations of the formation of elevations 160 and design elements 130 on surfaces 106, 108 of a molded part 100. In this case, elevations 160 may not only be circular, but may also have an elongate and/or curved profile. Polygonal cross sectional shapes are also possible and can be realized by a corresponding design of openings 234 for extracting steam in the molding surfaces of molding tools 200.

Elevations 160 can be components of a design element 130 and follow a profile of elements (e.g., a web 132), or can themselves be a design element, e.g. a letter (“L”).

In further embodiments, character strings or symbols can also be realized by several appropriately designed elevations 160, which, for example, give a consumer an indication of use or disposal.

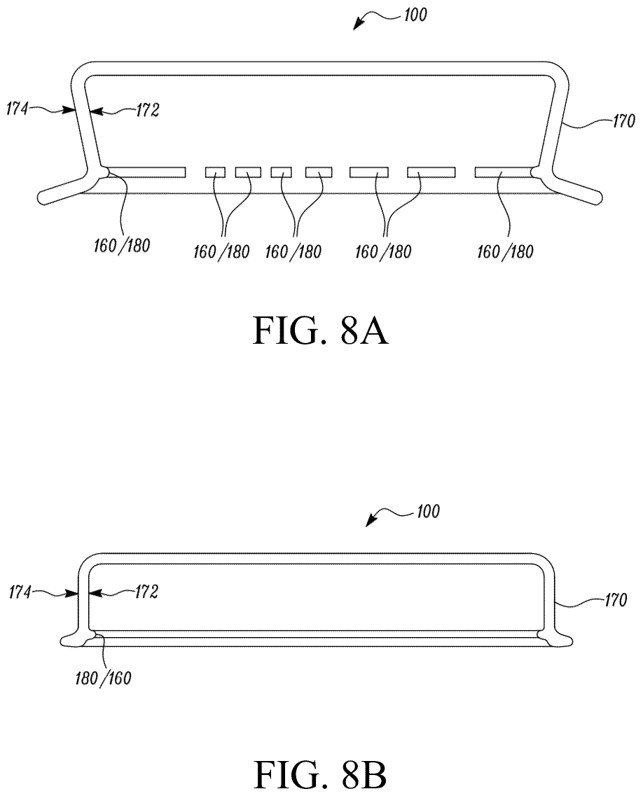

FIGS. 8A-8B depict schematic representations of a molded part 100 with elevations 160, which are designed as functional elements 180 in FIGS. 8A and 8B. The functional elements 180 serve to form an undercut. In the figures, the molded parts 100 are designed as a lid, which can be placed, for example, on a cup. To ensure that the lids are securely held on a cup, e.g., on a bead-like edge of a cup or the like, they have an undercut. In FIG. 8A, a side wall 170 is already formed with an inwardly tapering side wall portion that forms an undercut. To reinforce the undercut, the elevations 160 are located in this side wall portion, so that the elevations 160 form functional elements 180 that reinforce the undercut, where the inner diameter is further reduced and thus a holding effect on an edge is improved.

In FIG. 8A, the elevations 160 are located on an inner side 172 of the side wall 172. The functional elements 180 can be designed as webs with a freely selectable width or as a continuous elevation 160, as shown, for example, in FIG. 8B. FIG. 8B depicts a molded part 100 designed as a lid with a substantially parallel aligned side wall 170, which has a circumferential elevation 160 as a functional element 180 (undercut) on the inner side 172, where the undercut is formed here only by the elevation 160.

The elevations 160 can, for example, be formed by short portions or longer portions, as indicated in FIG. 8A. Alternatively, a functional element 180 can be formed by a closed elevation 160.

A molding tool has corresponding openings for the formation of such functional elements 180 or elevations 160, which can be designed, for example, as slots or slot-like openings (for the embodiments of FIGS. 8A-8B). In further embodiments, steam removal can thus only be provided by the elevations 160, which form at least one functional element 180, so that a molded part 100 cannot have any further elevations 160.

In still further embodiments, functional elements can also be provided on an outer side 174. In addition to providing undercuts, functional elements 180 can also serve, for example, to provide linear strips or ribs on a surface of a molded part 100, which have a specific function (“cooling fins,” retaining strips, etc.).

FIG. 6 depicts a schematic representation of a molding tool 200 for producing molded parts 100 from fiber-containing material.

In the exemplary embodiment depicted, the molding tool 200 has a first tool part 210 and a second tool part 230. The first tool part 210 and the second tool part 230 include or consist essentially of a metal (e.g., aluminum) or a metal alloy, which are suitable for pressing fiber-containing material at temperatures in the range of 120 to 300° C. and a pressure of 0.2 to 300 N/mm². The tool parts 210, 230 each have a molding surface 212, 232 for pressing fiber-containing material. The molding surfaces 212, 232 may also have a special surface coating or design to prevent damage to the molding surfaces 212, 232 due to the moisture contained in the fiber-containing material and the steam escaping during pressing.

In the exemplary embodiment depicted, the lower molded part 210 has a heating device 220. In further embodiments, the heating device 220 may extend into an upper molding region and/or have further heating elements. In still further embodiments, the upper tool part 230 may additionally or alternatively have a heating device with at least one heating element. Heating devices can, for example, have heating elements in the form of electrically controllable heating cartridges, etc.

FIG. 6 depicts a single pair of two corresponding tool parts 210, 230. In further embodiments, a molding tool 200 may include several pairs of tool parts 210, 230, each of which may be reversibly connected to a tool table or plate. This means that several molded parts 100 can be produced simultaneously in one molding step during production. In further embodiments, at least one tool table or tool plate can have a heating device that provides at least basic heating. In this case, additional heating devices 220 can be provided for the pairs of tool parts or one of the tool parts 210, 230 per pair of tool parts 210, 230.

In the exemplary embodiment depicted, the lower tool part 210 has a substantially smooth molding surface 212. The molding surface 232 has openings 234 through which the moisture that arises during the pressing of fiber-containing material under high pressure and due to the temperature introduced via at least the tool part 210 and that escapes from the fiber-containing material in the form of steam is removed. For this purpose, channels 236 run from the openings 234 through the tool part 230. In the exemplary embodiment depicted, the channels 236 open into a common channel that is connected via a connection to further devices for discharging the steam. For example, devices for generating negative pressure can be connected to it so that the resulting steam is actively extracted.

In further embodiments, several connections can be provided, through which the steam can be discharged from a tool part 230 or 210. In further embodiments, a lower tool part 210 can also have openings 234 and channels 236.

Due to the openings 234, elevations 160 are formed on the inner and/or outer surface 108, 106 of a molded part 100, indicated schematically by the dashed lines, as described above. Although the extension of the elevations 160 and their dimensions are relatively small and can be influenced by appropriate dimensioning of the openings 234, elevations 160 are visually and haptically perceptible in previously known embodiments and molded parts. The solution of integrating elevations 160 into surface portions 120 and design elements 130, which has already been presented with reference to the embodiments of FIGS. 1 to 5, offers the advantage that the elevations 160 visually fit into the shape of a molded part 100 or a design element 130 and are therefore neither visually nor haptically disturbing.

The molding tool 200 depicted is simply designed to form such molded parts 200 and has no moving components on the molding surfaces 212, 231, which are required for integrating the elevations. Thus, with the presented tool design, the integration of the elevation 160 can be easily implemented.

To form design elements 130 with regions 140, the molding surface 232 has bulges 238, for example to produce an element 130 on the side wall 110 of a molded part 100, as shown in FIGS. 3A-3B. In addition, an elevation 160 can be integrated into such a region 140, for which purpose a bulge 238 has an opening 234 at the selected location for extracting steam.

The formation of the bulges 238 on the molding surfaces 232 allows molding in the molding direction F_{D} without additional moving elements, since the molding surfaces 212, 232 in the region of the bulges 238 form no undercut. The bulges form molded elements of the molding tool part 230 and protrude into the molding space defined by the molding surface 232. In further embodiments, molded elements or bulges 238 can be designed so that, for example, regions with reduced material thickness can be formed in molded parts 100, as depicted, for example, in FIG. 7.

The openings 234 shown as examples are located in the exemplary embodiment at the position of the molding surface 232, which serve for the formation of design elements 130 and/or at first surface portions 120.

The production of molded parts 100 from a fiber-containing material includes a step of providing fiber-containing material that, for example, has a moisture content of between 50 and 70 wt. %, so that steam is generated during pressing, which steam must be removed from the cavity of a molding tool 200 between the molding surfaces 212, 232. Since the generation of steam is crucial during pressing, it is the moisture content and not the type of material that matters. For example, steam may only need to be removed locally. Thus, steam removal can be part if a wet (forming) process or a dry (forming) process can be used.

In a so-called wet process, preforms made of a fiber-containing material can first be provided, which are then pressed under the action of heat. The preforms can be prepared in such a way that fibers are suctioned out of an aqueous solution (pulp) and three-dimensional preforms are formed that substantially already have the shape of the products to be manufactured. In addition, additives such as starch, chemical supplements, wax, etc. can be added to a pulp to influence the properties of the products to be manufactured (e.g., barrier properties) and the processability. The fibers can be, for example, natural fibers, such as cellulose fibers, or fibers from a fiber-containing original material (for example waste paper). Since a fiber-containing pulp with natural fibers can be used as the starting material for the molded parts 100, after being used, the molded parts 100 produced can themselves once again be used as a starting material for producing molded bodies 100 or other products, or they can be composted, because they can usually be completely decomposed and do not contain any dangerous substances that are harmful to the environment.

In other embodiments, the preforms can be subjected to a pre-pressing step. The preforms are then pressed into three-dimensional molded parts 100 in a molding tool 200 under pressure and the action of heat.

Furthermore, the molded parts 100 can be formed from a loose cellulose web (airlaid) or a paper that has at least locally a sufficient moisture content.

After molding in the molding tool 200, produced molded parts 100 can be ejected, which can then be subjected to post-treatment in another device or in the same device. Post-treatment may include, for example, lamination, printing, etc. In further embodiments, molded parts 100 can be treated in other ways after their production, in order to achieve certain properties.

The formation of molded parts 100 can vary depending upon the desired form.

### List of Reference Signs

100 Molded part
102 Base
104 Base ring
106 Outer surface
108 Inner surface
110 Side wall
112 Ring
114 First transition
116 Second transition
120 First surface portion
122 Second surface portion
130 Design element
132 Web
140 Region
142 First sub-region
144 Second sub-region
146 Initial region
148 Ridge
150 Edge
160 Elevation
162 Pattern
170 Side wall
172 Inner side
174 Outer side
180 Functional element
200 Molding tool
210 First tool part
212 Molding surface
220 Heating device
230 Second tool part
232 Molding surface
234 Opening
236 Channel
238 Bulge

1. A three-dimensional molded part made of fiber-containing material, wherein the molded part is produced in a manufacturing process under pressure and thermal influence, wherein a surface of the molded part has at least one design element and/or functional element that is formed by at least one region with a reduced material thickness, and wherein the material thickness of the at least one region decreases with an increasing molded part height in a molding direction.

2. The molded part according to claim 1, wherein the surface has an orientation inclined with respect to a vertical axis of the molded part such that a cross-sectional area of the molded part increases in the molding direction.

3. The molded part according to claim 1, wherein the at least one design element and/or the functional element has at least one elevation that is formed by fiber-containing material that, during the manufacturing process of the molded part, has been sucked into a corresponding opening in a molding surface of a molding tool when steam that escapes from the fiber-containing material during pressing is removed.

4. The molded part according to claim 3, wherein the at least one elevation is arranged in a first surface section that has a different configuration than an adjacent at least one second surface section, wherein the at least one elevation is integrated into a configuration of the first surface section.

5. The molded part according to claim 3, wherein the at least one elevation is arranged on an outer surface of the molded part and extends from the outer surface away from the molded part.

6. The molded part according to claim 3, wherein the at least one elevation has an oval, elongate, polygonal, or round cross section at least in portions.

7. The molded part according to claim 3, wherein the at least one elevation is formed as a design element and/or a functional element.

8. The molded part according to claim 1, wherein the surface, the design element, and/or the functional element have elevations that are formed by fiber-containing material that has been sucked into corresponding openings in a molding surface of a molding tool during the manufacturing process of the molded part when steam that escapes from the fiber-containing material during pressing is removed, and wherein the elevations form at least one pattern.

9. The molded part according to claim 8, wherein the elevations are arranged on an outer surface of the molded part and extend from the outer surface away from the molded part.

10. The molded part according to claim 8, wherein at least one of the elevations has an oval, elongate, polygonal, or round cross section at least in portions.

11. The molded part according to claim 8, wherein at least one of the elevations is formed as a design element and/or functional element.

12. The molded part according to claim 1, wherein the fiber-containing material includes at least 50 wt. % of plant fibers and/or cellulose fibers.

13. A molding tool for producing molded parts from fiber-containing material, wherein the molding tool has at least one molding surface for pressing fiber-containing material into a three-dimensional molded body, wherein the at least one molding surface surrounds a molding space for pressing the fiber-containing material, and wherein the at least one molding surface has at least one molded element that projects increasingly from the at least one molding surface in a molding direction.
